(19) United States
(12) Patent Application Publication
(10) Pub. No.: US 2004/0177083 A1
(43) Pub. Date: Sep. 9, 2004

(54) System for enhanced monitoring of industrial project supply

(75) Inventors: Daniel Cheminais, Saultain (FR); Didier Hornet, Velizy-Villacooublay (FR); Arnaud Parde, Paris (FR)

Correspondence Address: GREENBLUM & BERNSTEIN, P.L.C., 1950 ROLAND CLARKE PLACE, RESTON, VA, 20191, US

(73) Assignee: VALLOUREC MANNESMANN OIL & GAS FRANCE, Aulnoye Aymeries (FR)

(21) Appl. No.: 10/800,703

(22) Filed: Mar. 16, 2004

Related U.S. Application Data
(63) Continuation of application No. PCT/FR02/03153, filed on Sep. 16, 2002.

(30) Foreign Application Priority Data
Sep. 17, 2001 (FR) 0111999

(51) Int. Cl. G06F 17/00

(52) U.S. Cl. 707/100

(57) ABSTRACT

Method implemented on a computer of monitoring a supply between at least one supplier and at least one client. A client site has at least one project, each project is associated with dated requirements for products, a state of a stock of the products and purchases of the products being known. The method including creating a list of product types required for each project, and producing at least one table for each product type for a sequence of time slices having a chosen time origin. The at least one table has a first running total for each time slice from the time origin up to a time slice of interest of a first quantity associated with the dated requirements of the client site. The at least one table further has a second running total for each time slice from a time origin up to a time slice of interest. This Abstract is not intended to define the invention disclosed in the specification, nor intended to limit the scope of the invention in any way.

### CROSS-REFERENCE TO RELATED APPLICATIONS

The instant application is a continuation of International Application No. PCT/FR02/03153 filed on Sep. 16, 2002 and published as International Publication WO 03/025810 on Mar. 27, 2003, the disclosure of which is hereby expressly incorporated by reference hereto in its entirety. The instant application also claims priority under 35 U.S.C. §119 of French Application No. 01 11999 filed on Sep. 17, 2001.

### BACKGROUND OF THE INVENTION

1. Field of the Invention

The invention concerns the monitoring of supply between supplier(s) and client, for industrial projects, and in particular non-exclusively weight projects. However, the invention is not limited to such projects.

2. Description of the Prior Art

In certain fields, lean supply can be both critical and particularly tricky to implement. This is the case, for example, for oil drilling operations, and their supply with metal pipes of various types.

It is known how to see to it that, on the drilling site (the client site), each drilling well (or project) is associated with a dated state of requirements of metal pipes (upstream products) of various types and dimensions. At the same time, there is kept a state of the stocks of these upstream products, as they exist on the drilling site. Orders are placed with the pipe supplier according to these states. However, the manufacturing times of the pipes at the supplier and the transit times between the supplier site and the client site lead on the one hand to providing on the client site and/or on the supplier site or sites fairly large stocks in order to meet any unforeseen event or any change to a project in progress, and/or on the other hand to accepting delays in the execution of this project. These constraints are onerous in a field such as that of oil drilling. Furthermore, it is difficult to manage these constraints other than project by project.

### SUMMARY OF THE INVENTION

The present invention aims to improve the situation.

It offers on the one hand a computerised method of monitoring lean supply between supplier(s) and client, in which, on a client site, each project (Pᵢ) is associated with a dated state of requirements (Iᵢ, tᵢ) of products, at the same time as there is kept a state of the stocks (Sⱼ, tⱼ) and purchases (Aₖ, tₖ) of these products, wherein the process comprises the following:

a. producing a list of product types (Iᵢ) involved in one or more projects (Pᵢ);

b. for each upstream product type (Iᵢ), producing a running total, in at least one table (Bₚ, Rₚ), and for a sequence of time slices, having a chosen time origin. For each time slice, the first running total, from the time origin up to the time slice concerned, of a first quantity (Bₚ) linked to the dated requirements (Iᵢ, tᵢ) on the client site. For each time slice, a second running total, from the time origin up to the time slice concerned, of a second quantity (Rₚ) linked to the stocks (Sⱼ, tⱼ) and the purchases (Aₖ, tₖ). The purchases are shifted timewise according to a delay; and

c. looking for the times at which the second running totals become less than the first, as indicators of a risk of supply shortage and/or a necessity of initiating supply.

“Purchases” above can mean the purchases made, ordered, planned, or even simply envisaged (purchase requirements). One of these options can be chosen by construction. In a variant, one or more of the options can be made available to the user, by selection, according to the desired analysis mode. The delay can be a delay of supply or of availability on site, or a delay linked to one and/or the other thereof, directly or indirectly.

The invention offers, moreover, a computerised system for monitoring lean supply between supplier and client. The system comprises a monitoring module (50, 52) capable of maintaining in memory a dated state of requirements of products (Iᵢ, tᵢ), associated with one or more projects (Pᵢ) at the same time as a state of the stocks (Sⱼ, tⱼ) and the purchases (Aₖ, tₖ) of these products. The monitoring module comprises a control module (54), and this control module also includes a requirements module (612a) capable, for each product type, of producing a first table, associated with a sequence of time slices, having a chosen time origin, this first table associating with each time slice a first running total of requirements (Rₚ), from the time origin up to the time slice concerned. A resources module (612b), capable, for each product type, of producing a second table, associated with the sequence of time slices, this second table associating with each time slice a second running total (Bₚ) of stocks plus purchases, from the time origin up to the time slice concerned. The purchases are shifted timewise according to a delay (DA; DI). A comparator (618) for looking for the times at which the second running totals become less than the first, as indicators of a risk of supply shortage.

The above description is a functional view of the system. According to another view, the monitoring module comprises a running total module (612), capable of receiving as parameters the designation of a product type, a mode and a time origin, and of producing, for the designated product type, a table associating with successive time slices a running total of product quantities, defined by the mode, each running total going from the time origin up to the time slice concerned. A control module (54), arranged for calling the running total module (612) with a product type, and a mode comprising the running total of requirements on the client site, which supplies a first table, arranged for calling the running total module (612) with the same product type, and a mode comprising the running total of stocks plus supplies (for example, deliveries), which supplies a second table. The control module is arranged for looking for (618) the times at which the running totals in the second table become less than those in the first table, as indicators of a risk of supply shortage.

The invention also provides for a product program, which can be defined as comprising the functions for executing operations “a” to “c” of the above-noted method, and/or one that comprises the functions of the control module in the system defined above.

The invention can also cover a higher level product program, forming a precursor of the product program mentioned above. In one object-oriented programming embodiment, this higher level product program can comprise object classes, and a generic version of the control module.

The invention also provides for a method implemented on a computer of monitoring a supply between at least one supplier and at least one client. A client site has at least one project. Each project is associated with dated requirements for products, and maintaining a state of a product stock and product purchases of the products being known. The method includes creating a list of product types required for each project, producing at least one table for each product type for a sequence of time slices having a chosen time origin. The at least one table has a first running total for each time slice from the time origin up to a time slice of interest of a first quantity associated with the dated requirements of the client site. The at least one table has a second running total for each time slice from a time origin up to a time slice of interest, of a second quantity associated with the stock and the purchases. The purchases are shifted timewise according to a delay in time. The method also including searching the at least one table for times at which the second running total is less than the first running total which is indicative of a risk of at least one of a supply shortage and a necessity of initiating supply.

The method may further comprise periodically shifting the running totals to a new time origin, when there is substantial equality between first totaled quantities and second totaled quantities. The creating and the producing may be reiterated in view of predetermined events. The predetermined events may comprise at least one of modification of a project date by the at least one client, modification of an availability date by the at least one client, modification of a supply delay by the at least one supplier, modification of product quantities to be provisioned, placing of an order from the at least one client to the at least one supplier, confirmation of an order, reservation of a product from stock, and delivery of a product.

The searching may further comprise taking an order no later than a date substantially equal to a start-up date of a project, wherein the date is increased by supply availability and reduced by a supply delay.

The producing may further comprise classifying requirements of the stock and the purchases by product and by effective date, forming a running total of the requirements for each product and in each time slice in a sequence, from a time origin, to create a first table, and forming a running total of the stock and deliveries provided for each product, and in each time slice in the sequence, from the time origin to create a second table.

The invention also provides for a system for monitoring a supply between at least one supplier and at least one client using a computer. The system comprises a monitoring module configured to maintain in memory a dated state of requirements for products associated with at least one project and further configured to concurrently maintain in memory a state of stock and purchases of the products. In particular, the monitoring module comprises a control module which includes a requirements module that is configured to produce, for each product type, a first table associated with a sequence of time slices having a chosen time origin. The first table associates with each time slice a first running total of requirements from a time origin up to a time slice of interest. A resources module that is configured to produce, for each product type, a second table associated with a sequence of time slices. The second table associates with each time slice a second running total of stock and purchases from the time origin up to the time slice of interest. The purchases are shifted timewise according to a delay in time. A comparator searches for times at which second running totals are less than first running totals which are indicative of a risk of a supply shortage.

The invention further provides for a system for monitoring a supply between at least one supplier and at least one client. The system comprises a monitoring module configured to maintain in memory a dated state of requirements of products associated with one or more projects and configured to maintain in memory, at the same time, a state of the stock and purchases of the products. The monitoring module includes a running total module that receives, as parameters, a designation of a product type, a mode, and a time origin. The running total module produces, for the designated product type, a table associating successive time slices with a running total of product quantities being defined by the mode, so that each running total goes from the time origin up to a time slice of interest and a control module that calls the running total module with a product type and a mode of requirements on a client site, to which the running total module supplies a first table. The system provides for calling the running total module with the same product type, and a mode of stock and deliveries, to which the running total module supplies a second table and searching for times at which the running totals in the second table become less in the first table, which are indicative of a risk of supply shortage.

The control module may periodically shift the running totals to a new time origin when there is a substantial equality between the first totaled quantities and the second totaled quantities. The control module may operate in a reiterated manner in view of predetermined events. The predetermined events may comprise at least one of modification of a project date by the client, modification of an availability date by the client, modification of a supply delay by the supplier, modification of the product quantities to be provisioned, placing of an order from the client to the supplier, confirmation of an order, reservation of a product from stock, and a delivery of a product. The control module may order a product, no later than a date substantially equal to a start-up date of the project, increased by a supply availability, and reduced by a supply delay.

The system may further comprise a state module, capable, on the client side, of classifying the requirements of the stock and the purchases, by product and by effective date, forming a running total of the requirements for each product in each time slice in a sequence to create the first table, and forming a running total of the sum of stock and purchases for each product, and in each time slice in the sequence, to create the second table, the control module operating from the data of the state module.

The control module may at least partially incorporate the state module the monitoring module may manage a list of product types involved in one or more projects.

The system may be implemented in object-oriented programming and further comprise an object class for the products, an object class for the stock, an object class for the purchases, and an object class for a table element comprising a quantity and a time.

The system may further comprise an object class for a project.

The invention also provides for a computer readable medium product comprising a program for executing any of the methods described above.

The invention also provides for a computer readable medium product comprising a program for implementing functions of the monitoring module in any of the systems described above.

The invention still further provides for a computer readable medium comprising a program in object-oriented programming, wherein the program implements functions of the monitoring module and anyone or more of the object classes described above.

### BRIEF DESCRIPTION OF THE DRAWINGS

The present invention is further described in the detailed description which follows, in reference to the noted plurality of drawings by way of non-limiting exemplary embodiments of the present invention, in which like reference numerals represent similar parts throughout the several views of the drawings, and wherein:

FIGS. 1 and 1a depict the known general structure of an oil well, schematically restricted to the requirements of the present description;

FIG. 2 is a sectional view illustrating the known assembly of two pipes using threaded and coupled connections;

FIG. 2a is a modified version of a pipe connection similar to that of FIG. 2 but without using a connecting sleeve or coupling (integral connection);

FIG. 3 is a flow diagram illustrating the manufacture and assembly of elements such as those of FIG. 2;

FIG. 4 is a diagram illustrating a known interaction between a client site and a supplier site;

FIG. 5 is a modified version according to the invention of the diagram of FIG. 4;

FIG. 6 illustrates functions located in a computer system;

FIG. 7 is a flowchart of the operations used for implementation of the invention, in one embodiment;

FIG. 8 is a graph forming a first mode of displaying the product of the invention;

FIG. 9 is a table forming a second mode of displaying the product of the invention; and

FIG. 10 is an object schema illustrating an advantageous variant of the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The drawings contain, essentially, elements of a certain nature. They can therefore not only be used to make the description understood more clearly, but also contribute towards the definition of the invention, if need be.

The present description is supplemented by an appendix which defines: in section A.1.0, notations; in section A.1.1, basic elements for implementation of the invention; and in section A.1.2, software objects and their properties, in the case of an object-oriented programming implementation.

Reference can be made to the sections of this appendix, which is located in this description in a single area only for the sake of clarity, and which forms an integral part of the description.

The instant document may contain elements liable to protection by authors rights (droit d'auteur) or copyright. The holder of the rights has no objection to the identical reproduction by anyone of this patent document, as it appears in the files and/or publications of the patent offices. On the other hand, as for the rest, the holder reserves the whole of authors rights and/or copyright.

The detailed description below will be directed principally with reference to the case of an oil drilling site, by way of a non-limiting example. Rigs are used for producing oil and gas, at each well on a site. Such a well includes an assembly of steel pipes and/or of a number of different types of pipes.

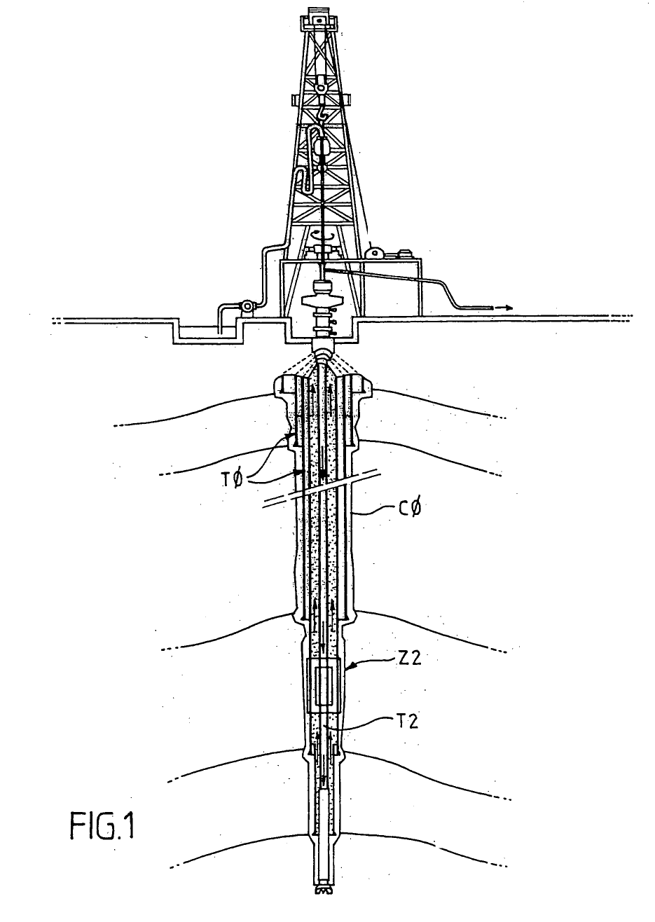

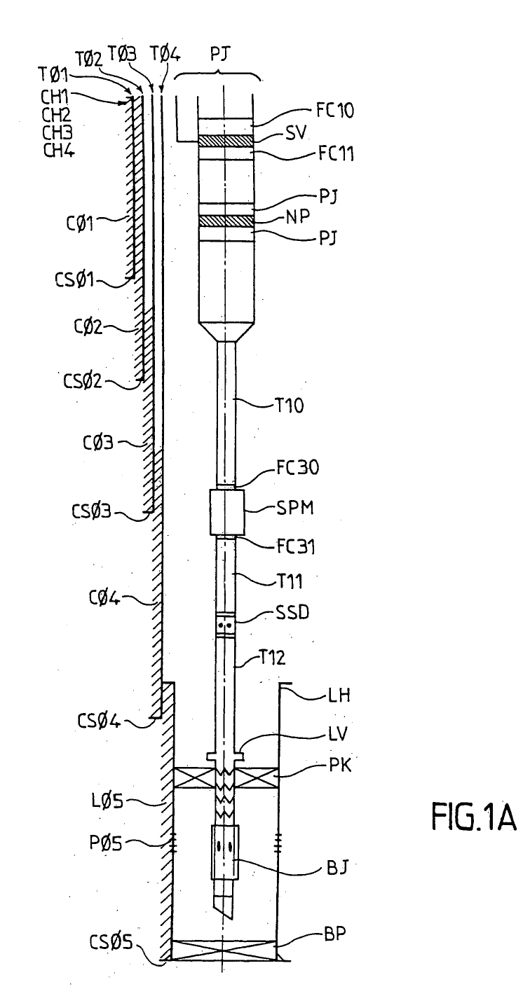

FIG. 1 depicts a well in the process of being drilled with a number of concentric columns of casings, denoted T0. These casings T0 are shown in black lines and are surrounded by cement C0 in a grey-tinted area. Arranged at a center is a set of drill pipes T2. Drilling fluid travels down this set of drill pipes, which makes it possible in particular to clear the fragments of drilled rocks. In the area Z2, there are, for example, on the periphery a casing joint, and, at the center, a drill pipe joint.

FIG. 1A shows again the casing, pipes T01 to T04, suspended by blocks forming casing hangers CH1 to CH4, surrounded by layers of cement C01 to C04, each of which ends at the bottom with a cementing shoe CS01 to CS04. The casing continues with a liner L05, oriented according to the geometry of the reservoir and perforated, for example, at P05 in order to allow passage of the oil or gas which will be raised by the tubing. The liner L05 is held by a liner hanger LH. The production string is constituted by tubings and a number of accessories which are, amongst others, the safety valve SV and a side pocket mandrel SPM, themselves enclosed by cross-overs CO or pup joints PJ or else by flow couplings FC.

The production string is suspended, at the top, by a tubing hanger TH and furthermore comprises a number of packers, such as, for example, PK and BP.

Of course, the production string is lowered only once the drilling is finished and comes in the place of the set of drill pipes.

Each well therefore requires different types of pipe, which must be manufactured and assembled on pipe production sites and conveyed to the drilling site, where they are assembled to a greater length in the well. Moreover, each well also requires the assembly of a number of other subassemblies or accessories, which will be discussed later.

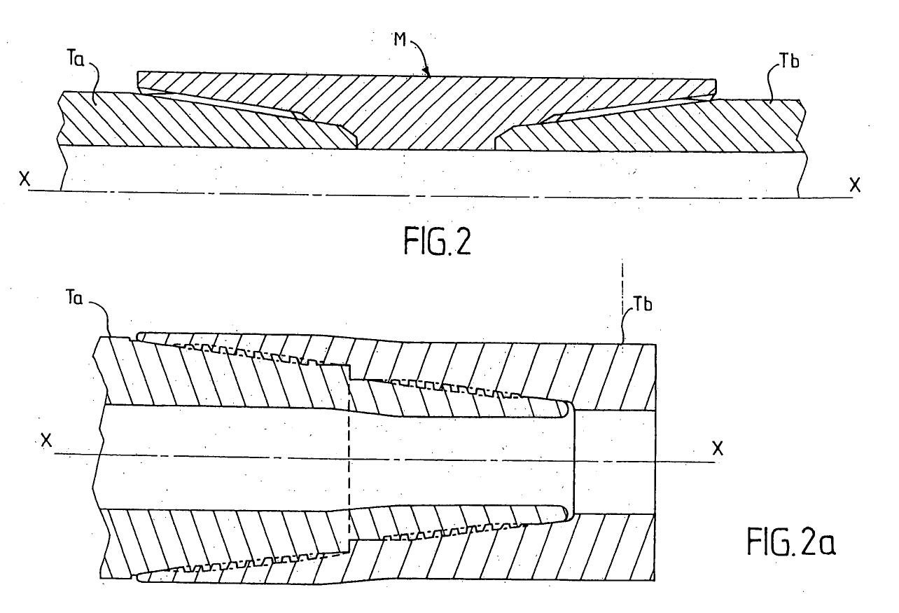

FIG. 2 shows two pipes Ta and Tb, assembled by way of a threaded sleeve or coupling M. As regards pipe production, a sleeve M is assembled at one end of a pipe, for example Ta. The pipes are then transported in unit lengths (of approximately 10 m) with one end sleeved. Assembly into longer lengths of the free end of the sleeve with the non-sleeved end of another pipe is carried out under the rig, and generally during the lowering of the pipes into the well.

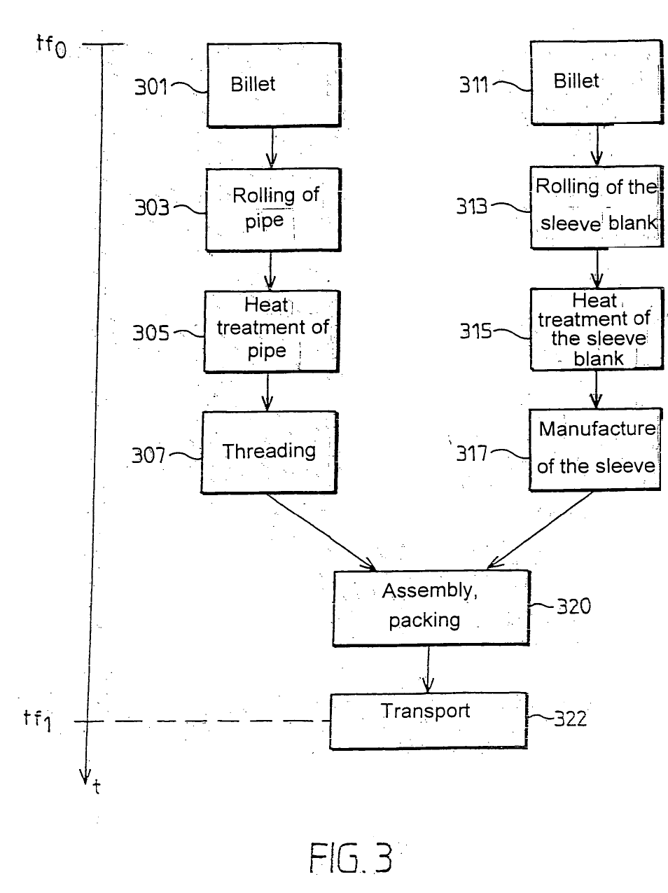

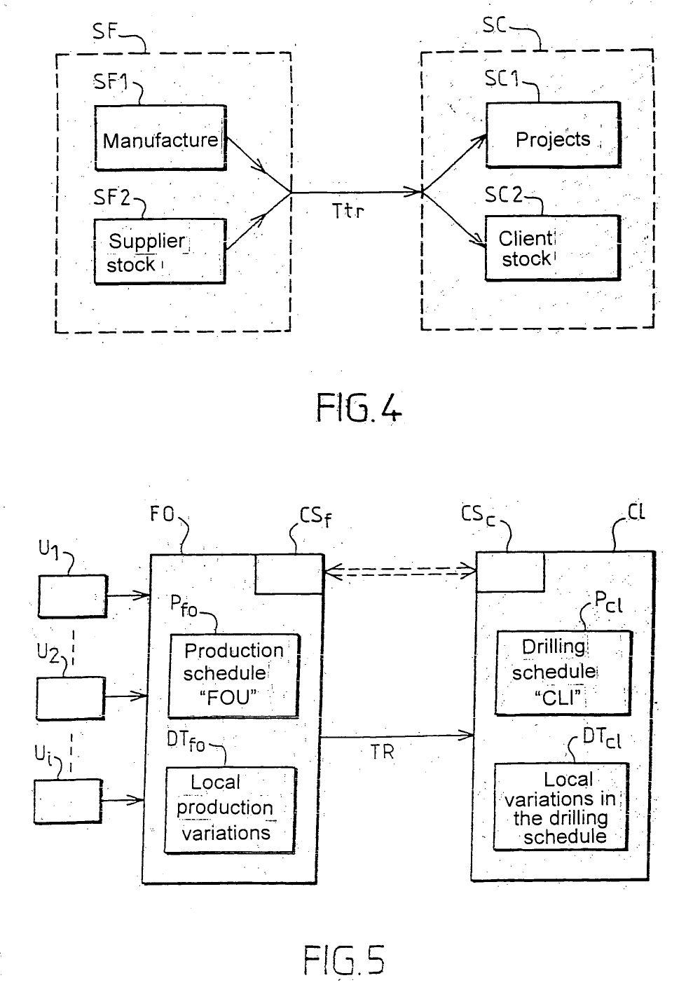

Making an assembled tubular product available on the drilling site involves many operations, which will now be described with reference to FIG. 3, the left-hand part of which is a time scale directed downwards, from a beginning time and/or an initial instant t_{f0}, a little later than the receipt of an order, to an end time and/or a final instant t_{f1}, which represents the moment when the tubular product is on the drilling site.

As shown in FIG. 3, the pipes are produced from a billet operation 301, then subjected to a rolling operation at operation 303, and then to a heat treatment at operation 305. The pipe ends are then threaded at operation 307 for receiving the sleeve.

FIG. 3 also illustrates that the sleeve is manufactured from a billet at operation 311, then rolled at operation 313, then subjected to a heat treatment at operation 315, and then, at operation 317, it undergoes cutting and threading operations.

At operation 320, the pipes are next assembled with their sleeves, as illustrated in FIG. 2, so as to have a long size (generally defined by the limiting transport constraints) and the assembly is packed for transport. The final transport operation at 322 conveys these tubular products to the drilling site.

A variant of the above-noted process includes connecting two pipes without resort to an intermediate sleeve, as illustrated in FIG. 2a. In this case, the process is modified so that one of the pipes receives a male thread, the other a female thread.

Schematically, in the current situation, a supplier site SF carries out the manufacturing operations of FIG. 3 at SF1, and also performs supplier storage at SF2.

On the client site SC side, there are projects SC1, in this case a plurality of drilling operations, and stocks of tubular products SC2. Between the two sites, a transport time Tₜᵣ has to be provided for. On the client side, the stock SC2 is also supplied by reconditioning of pipes coming from rigs (after use). These overhauled or reconditioned products become available again after checking. This is a significant source of variation in the stocks.

In fact, the operations are a little more complex, as shown by FIG. 5.

The supplier FO will generally use a number of different factories which are arranged and/or located at different locations U₁ to Uᵢ (the rolling mills are for example installed at fixed sites). The supplier will therefore implement a supplier production schedule Pfo, in which the supplier must take account of local production variations DTfo, if necessary.

On the client CL side, there also exists a drilling schedule (client production) Pcl, as well as local variations in the drilling schedule DTcl.

The interaction between the client site and the supplier sites takes place by way of the tubular product transport operations TR.

Currently, tubular products are delivered to oil-industry clients either from manufacturing following on from an order (which requires an implementation time of four to six months), or from a consignment stock managed on behalf of this client. These extremely onerous time and/or storage constraints generate costs, which it is necessary to attempt to reduce.

In particular, the problem arises for the pipe manufacturer of delivering tubular products relating to rigs, as far as possible, with no intermediate stock, that is to say “just in time”. It is also desirable to reduce the delay between order confirmation and delivery on site to six weeks, at the very least for standard pipes.

Of course, the tubular product requirements can change considerably depending on the change in the situation on the drilling site, itself dependent on events which can range from an unforeseen geological and/or prospecting event to an accident on the equipment.

It is conceivable to delegate a person on the drilling site, or close thereto, in order to update the pipe consumption forecasts as regularly as possible, to consolidate them, and to transmit them to those responsible for the planning of the pipe manufacturing factories.

However, when the number of rigs becomes large and the forecasts are reviewed very frequently, it is humanly impossible to manually bring the forecasts up to date reliably. Moreover, the link between the supply of tubular products and that of the associated accessories very quickly becomes complex.

The present invention aims to provide a solution to these problems.

According to one aspect of the invention, there is provided on the client sites CL a computer system CSc, preferably connected by network to a supplier side system CSf, for rapid transmission of information.

On the client side, at an instant ti, the product requirement Iᵢ for a well Pᵢ can be represented by a triplet of information given at A.1.1.a. In fact the product requirement Iᵢ is a function of the well Pᵢ and the time, as indicated at A.1.1.b.

On the supplier side, there is the ability, at an instant tj, to provide the client with a supply, following which the client has available a total quantity Sj of the product Iⱼ, as indicated at A.1.1.c (hereinafter this total quantity is referred to as “stock”, although it does not correspond exactly to a physical stock).

The optimisation problem posed includes, from the data Iᵢ and tᵢ for all the wells, of interacting in consequence on the stocks Sⱼ at the time tᵢ.

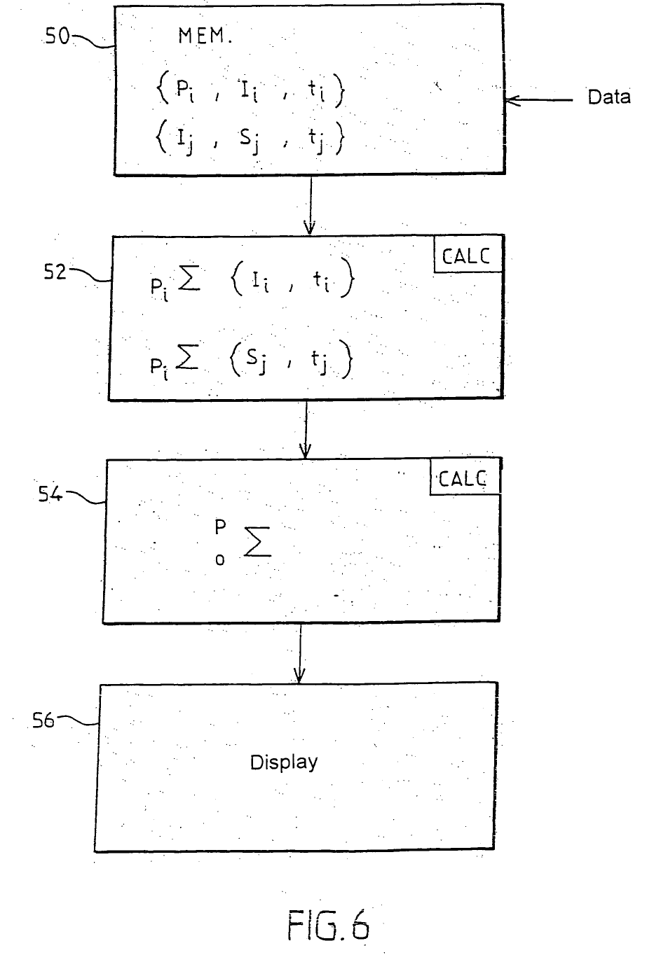

FIG. 6 illustrates functions located in a computer which can be, for example, a WEB IIS (Internet Information Service) server, operated under Windows NT.

At 50, the computer memory contains the quantities illustrated at A.1.1.a and A.1.1.c in the Appendix, which can be respectively viewed as the requirements by well and the state of the stock by product (ITEM). In a known manner, a data entry system has an effect on the contents of the memory 50. It can be based on data entered by operator, and/or drawn from computerised schedules of the site.

Conventionally, the requirements are managed by well. The invention makes provision, first of all at 52, that a summation is carried out on all the wells, which gives the two elements of the expression A.1.1.b, which can be considered respectively as a summation by ITEM and a state of the stock by ITEM. There results therefrom an apparent demand.

According to another aspect of the invention, there is added another running total system illustrated at 54 in FIG. 6, and which will allow, for example, a display 56 for the operator, as will also be seen. This system can also use a state of the reservation or order confirmations, as expressed at A.1.1.e.

The functioning of the mechanism 54 advantageously relies on object-oriented programming, using the objects defined at A.1.2. In Table A.1.2, the delay DA is defined as follows: if the product must be provisioned at the date J, its firm request must be confirmed no later than J-DA.

This mechanism will be described here for a given product “PROD_i”, but must of course be repeated for each product type necessary for a well, for example, the three classes of pipe T0, T1 and T2 described in connection with FIG. 1.

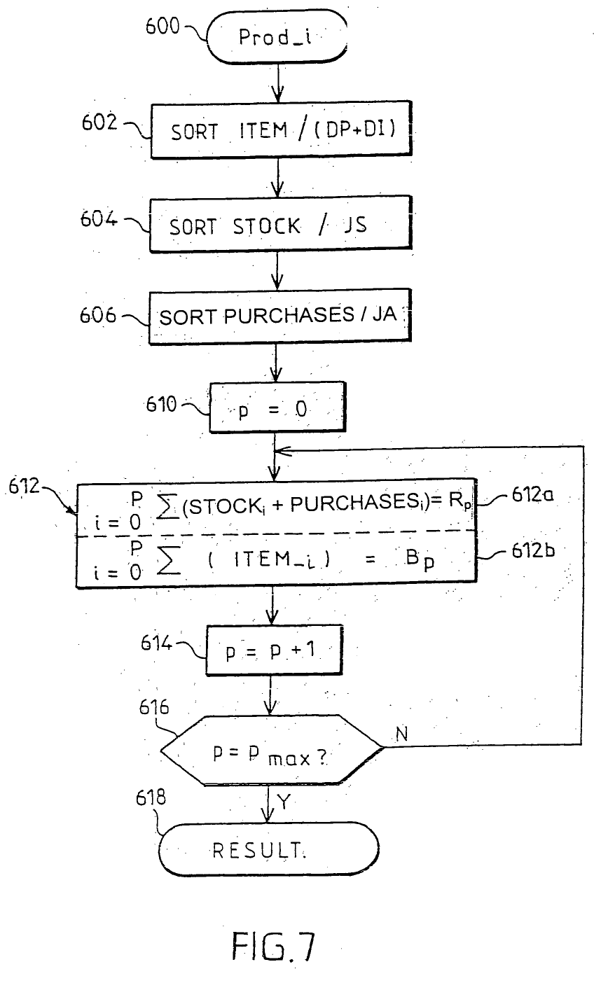

In FIG. 7, for a product PROD_i illustrated at 600, three sorting operations (expressed in the figure by the usual sorting instruction “SORT”) are performed, first of all, as follows:

operation 602 sorts the products (“ITEM” object) according to the sum of the dates DP and DI, namely the planned start-up date of the well, and the delay between the start-up date of the well and the requirement for the product on the site (all times are expressed in days in this example);

operation 604 sorts the products in stock (“STOCK” objects) by their date of entry into stock JS; and

operation 606 sorts the purchases, according to their planned supply date JA.

Of course, the three operations 602, 604 and 606 each time involve quantities, respectively QI, QS and QA.

The invention can be implemented by way of one or more (computer) tables, logical or physical.

Specialists in object-oriented programming will understand that an ITEM object is an instance of an ITEM class, having the properties defined in Appendix A. 1.2, each time with a corresponding value of the property, for example a quantity QI and a delay DI, if the ITEM object is concerned.

It should also be noted that the sorting of the ITEM objects involves a relationship between the ITEM and the well Pᵢ to which it is attached, since it is necessary to sum the dates DP and DI.

After these sorts, the invention makes provision to perform a running total from an initial instant t₀.

The running totals are performed on a sequence of time slices, starting from the instant t₀, and of chosen duration. In the example described, the time measurement unit is the day, and a time slice can be equal to one day, or a multiple of one day, if desired. The operation 610 includes setting to zero an index for a time slice in the sequence, denoted p.

At the operation 612, a summation (612a) is performed from the time slice 0 up to the time slice p of the sum of the stocks and purchases in each time slice, which provides a quantity Rp. Similarly, the sum is performed (612b) from the initial time slice up to the time slice p of the values ITEM_i during each of these time slices, which gives a result

The operation 614 increments p. If a maximum value, which corresponds to a future chosen range projection, if necessary able to be changed, has not been reached at 616, the operations 612 and 614 are reiterated. When the maximum value of p is obtained, use is made of the result at 618.

The form given to the operation 612 is purely illustrative. In fact, the procedure will rather be iterative: first of all the results R₀ and B₀ are calculated for the time slice 0, then during the following pass through the loop, R₁ and B₁ are calculated by adding respectively to R₀ and B₀ which corresponds to the time slice 1, and so on.

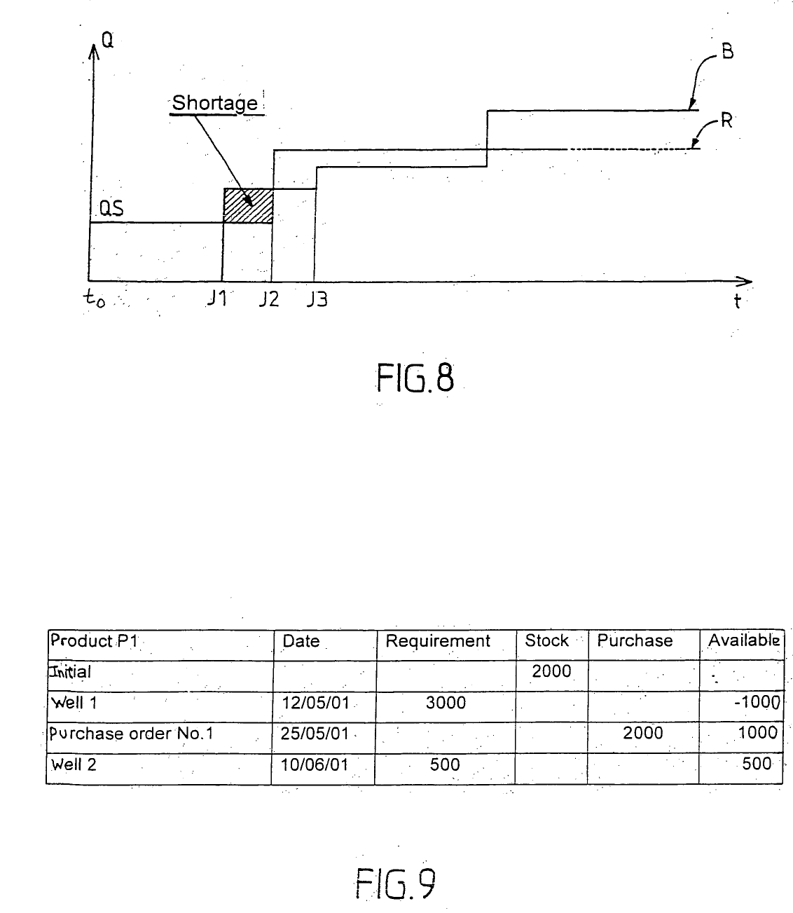

The set of results Bₚ for p=0 to pₘₐₓ is now denoted B, and the set of resources Rₚ for p=0 to pₘₐₓ is now denoted R. These quantities can be displayed as a function of time as shown in FIG. 8. The risks of supply shortage appear where the curve of requirements B is higher than the curve R of stocks plus reservations (stocks+orders made or programmed), for example, between the instants J1 and J2, as illustrated by hatching. These conditions can be evaluated by the computer at the step 618.

The above can be implemented using additional object classes, in particular, an object class (TABLE_ELEMENT) for a table element comprising a quantity (Q) and a time (t). An additional class can be provided for an array, called for example SEQUENCE, and comprising a TABLE_ELEMENT for each time slice in the sequence. The number of time slices can be made dynamically variable.

The results can be made available to the user in any other form, for example, in the form of the table illustrated in FIG. 9, which includes more information.

In one embodiment, the invention utilizes a plurality of different screen views of one and the same table grouping together all the information resulting from the processing.

The revealing of shortages must prompt the manager (the person representing the supplier at the premises of the client) to negotiate actions to be carried out as follows: supply request to suppliers, modification of a planned request (quantities, dates), or proposing developments. Automatic order generation is conceivable. Similarly, an acknowledgement can be added for placing in stock, for new products, or for returns of products reconditioned like new.

All the operations described above can be performed in the computer CSc present on the client site. They use the local production schedule Pcl, following the local production variations Dtcl. These operations constitute what is referred to as production control, which can be carried out by the client himself, by one of the suppliers, or by a third party. It is currently considered preferable for production control to be directed by the main supplier, or one of them. “Main supplier” means the one whose products are most important to the client, for example, in terms of criticality, and/or volume, and/or supply delay, in particular. The main supplier can also be the one who is best placed for managing the requirements of the client with regard to other suppliers.

The connection with a computer CSf placed on a supplier site makes it possible to immediately change the supplier production schedule Pfo, and also monitor the local production variations DTfo, if necessary.

Of course, the teachings of the present invention can also be implemented on the site of the supplier, optionally with regard to his own suppliers.

The fact of working in a network also allows for access to other databases, if need be, or other applications available on the network, totally transparently to the user.

Functionally, the invention offers a computerised system for monitoring lean supply between supplier and client, comprising a monitoring module (50, 52) capable of maintaining in memory a dated state of requirements of products (Iᵢ, tᵢ), associated with one or more projects (Pᵢ), at the same time as a state of stocks (Sⱼ, tⱼ) and purchases (Aₖ, tₖ) of these products. This monitoring module comprises a control module (54) which includes the following:

a requirements module (612a) capable, for each product type, of producing a first table, associated with a sequence of time slices, and having a chosen time origin. This first table is associated with each time slice a first running total of requirements (Rₚ), from the time origin up to the time slice concerned;

a resources module (612b), capable, for each product type, of producing a second table is associated with the sequence of time slices. This second table is associated with each time slice a second running total (Bₚ) of stocks plus purchases, from the time origin up to the time slice concerned, and the purchases are shifted timewise according to a delay (DA; DI); and

a comparator (618) for looking for the times at which the second running totals become less than the first, as indicators of a risk of supply shortage.

Computer-wise, the above-noted system calls upon two “logical” tables, namely a table of requirements and a table of resources (itself able to be broken down into a table of stocks and a table of purchases). In practice, a single “physical” table can be used, combining the above two (or more) tables, wherein the membership of one of the tables is, for example, indicated by a field dedicated for that purpose.

The invention also relates to a computerised method of monitoring lean supply between supplier and client, in which, on a client site, each project (Pᵢ) is associated with a dated state of requirements (Iᵢ, tᵢ) of products, at the same time as there is kept a state of the stocks (Sⱼ, tⱼ) and purchases (A,ₖt)ₖ of these products. This method advantageously comprises the following:

a. producing (50) a list of product types (Iᵢ) involved in one or more projects (Pᵢ);

b. for each upstream product type (Iᵢ), producing (612), in at least one table (Bₚ, Rₚ), and for a sequence of time slices, having a chosen time origin, wherein for each time slice, a first running total, from the time origin up to the time slice concerned, of a first quantity (Rₚ) linked to the dated requirements (Iᵢ, tᵢ) on the client site and wherein for each time slice, a second running total, from the time origin up to the time slice concerned, of a second quantity (Bₚ) linked to the stocks (Sⱼ, tⱼ) and the purchases (Aₖ, tₖ), the purchases being shifted timewise according to a delay (DA, DI); and

c. looking for (618) the times at which the second running totals become less than the first, as indicators of a risk of supply shortage.

In terms of computer processing, it is advantageous to use a single running total function. The invention can therefore also be viewed as a computerised system for monitoring lean supply between supplier and client, comprising a monitoring module (50, 52) capable of maintaining in memory a dated state of requirements of products (Iᵢ, tᵢ), associated with one or more projects (Pᵢ), at the same time as a state of the stocks (Sⱼ, tⱼ) and purchases (Aₖ, tₖ) of these products. This monitoring module comprises the following:

a running total module (612), capable of receiving as parameters the designation of a product type, a mode, and a time origin, and of producing, for the designated product type, a table associating with successive time slices a running total of product quantities, defined by the mode, each running total going from the time origin up to the time slice concerned; and

a control module (54), arranged for calling the running total module (612) with a product type, and a mode comprising the running total of requirements on the client site, which supplies a first table, arranged for calling the running total module (612) with the same product type, and a mode comprising the running total of stocks plus deliveries, which supplies a second table, and arranged for looking for (618) the times at which the running totals in the second table become less than those in the first table, as indicators of a risk of supply shortage.

The above operations are reiterated at a suitable rate considering the speed of change of the situation. Preferably, they are also reiterated in the presence of predetermined events, which can comprise at least one of the events in the group comprising: modification of a project date by the client, modification of an availability date by the client, modification of a supply delay by the supplier, modification of the product quantities to be provisioned, placing of an order from the client to the supplier, confirmation of an order, reservation of a product from stock, delivery of a product.

The method can also comprise the taking of an order, no later than a date substantially equal to the start-up date of the project concerned (DP), increased by an availability delay (DI), and reduced by a supply delay (DA).

It has been seen that the present invention works by running totals. The problem with a running total is that it normally tends to increase indefinitely. According to another aspect of the invention, the information is “resynchronised” periodically, by removal of data from the past, so as to limit its space requirement, as well as the processing times.

Advantageously, this resynchronisation can be carried out in the form of a resetting to zero of the running totals, each time the requirements substantially correspond to the resources, and, if need be, to an extent compatible with the necessity of retaining, in active form (other than archived), a “historical” view of the operation. At the time of resynchronisation, the residual difference between the requirements and the resources can be re-labelled as a stock.

In the example described, drilling pipes have been mentioned by way of example. The invention can be extended to various kinds of other products useful during drilling operations (or “well components”), in particular, those connected with pipes such as, e.g., so-called pup joints, intended in particular for adjusting the length of the tubings according to the actual length descended, and/or cross-overs (threaded connectors) used in situ, as well as more complex accessories, in general concerning specialist suppliers other than pipe manufacturers, such as, e.g., safety valves, and/or casing hangers, and/or cement shoes, and/or liner hangers.

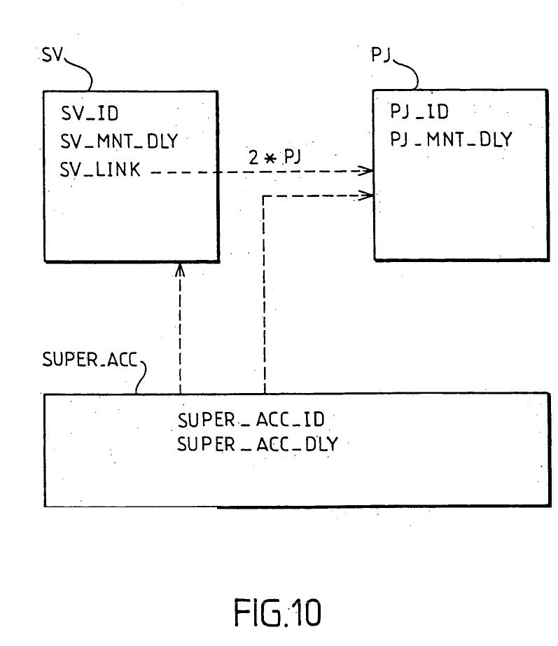

On another level, it can be advantageous to link certain of the well components with one another, in time and in quantities, in particular for accessories. One example thereof is illustrated in FIG. 10. It is common to mount a pipe accessory (“SUPER_ACC”), comprising two pup joints (“PJ”) associated with a safety valve (“SV”). Computer-wise, this then gives the following:

a “safety valve” object class SV, particularised by object attributes which can comprise an identifier SV_ID, a mounting time SV_MNT_DLY, and a property SV_LINK, which will be discussed later;

a “pup joint” object class PJ, particularised by object attributes which can comprise an identifier PJ_ID, and a mounting time PJ_MNT_DLY.

From this, a “pipe accessory” extended object SUPER_ACC can be defined which comprises one instance of the object class SV, and two instances of the object class PJ, which completely defines the accessory.

This can be obtained by the link SV_LINK, which is for example a method, then denoted SV_LINK( ), which can be activated in order to automatically designate, for example by their identifier or identifiers PJ_ID, the two pup joints which match with the identifier SV_ID of the safety valve which is the starting point for creating the accessory SUPER_ACC. The same method can also synthesise the installation delays SV_MNT_DLY and PJ_MNT_DLY, in order to directly define the anticipation delay SUPER_ACC_DLY, to be provided for the accessory SUPER_ACC. This simple example shows how it is possible to have well components linked with one another, in time (the delays) and in quantities (two PJs for one SV). It can easily be generalised to more complex cases.

Furthermore, the present invention is in no way limited to the application to drilling sites, mentioned in this detailed description. This application is particularly outstanding, in the sense that it involves very different products in large volumes, having long manufacturing times, requiring scattered manufacturing resources, and being difficult to transport, moreover with accessories, the whole for a client application which is weighty, large and evolving by nature. Beside that, the delivered tubular products are used as they are, or little modified. For pipes, in general only fairly simple operations are carried out on the client site: threading of the pipe in situ, or adaptation of pipes as derived products, such as the aforementioned pup joints, which can be dimensioned on site. These operations are moreover generally performed by the supplier, or a third party, on the client site.

The invention can of course apply a priori to other technical fields, where semi-finished products and non-immediate handling/transport, in particular of pipes, are widely used, with time constraints.

However, the invention also remains applicable to many other fields that possess all or some of the aforementioned constraints, irrespective of the time scale of development. The critical parameter in fact appears to be the relationship between the cost of possible lost time and the investment.

The present invention also relates to the software code that it involves with regard to the method or the system, more particularly when it is made available on any medium readable on a computer. The expression “medium readable by computer” covers a storage medium, for example magnetic or optical, as well as a transmission means, such as a digital or analogue signal.

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

### Appendix

A. 1.0—notations

Well: Pᵢ

dated state of the products (Item): (Iᵢ, tᵢ)

dated state of the stocks: (Sⱼ, tᵢ)

dated state of the purchases: (Aₖ, tₖ)

A. 1.1—basic elements

A.1.1.a {Pᵢ, Iᵢ, tᵢ}

A.1.1.b i=f(Pᵢ,t)

A.1.1.c {Iⱼ, Sⱼ, tⱼ}

A.1.1.d {Iᵢ, tᵢ}=>{Sⱼ, tᵢ}

A.1.1.e {Iₖ, tₖ}

A.1.2—Objects (software) and their properties

| OBJECTS | PROPERTIES (simplified) | |
|---|---|---|
| WELL | | Designation |
| | DP | Planned start-up date |
| | | Status {planned, specified, confirmed, |
| | | in progress, closed} |
| PRODUCT | | Designation |
| | DA | Maximum supply delay |
| | | Supplier |
| | | Status {product, accessory, etc. } |
| ITEM | QI | Quantity (metres of pipe) |
| | DI | Delay between start-up date of the well and |
| | | requirement for the product on the site |
| | | (in days) |
| | | Reference to the well |
| | | Reference to the product |
| | | Order number in the descent into the well |
| | | Comments |
| STOCK | QS | Quantity in stock |
| | JS | Date of entry into stock |
| | | Entry into stock reference (lorry, return, etc.) |
| | | Date of exit from stock |
| | | Date of last inspection |
| | | Pipe reference (factory mark) |
| | | Storage location (compartment) |
| PURCHASE | QA | Quantity to be provisioned |
| | JA | Planned supply date (output from factory) |
| | | Average transport time (factory-stock) |
| | | Internal order number |
| | | Supplier order number |
| | | Status {consultation, reservation, order} |

What is claimed:

1. A method implemented on a computer of monitoring a supply between at least one supplier and at least one client, in which a client site has at least one project, and each project is associated with dated requirements for products, and maintaining a state of product stock and product purchases, the method comprising:
creating a list of product types required for each project;
producing at least one table for each product type for a sequence of time slices having a chosen time origin, the at least one table having:
a first running total for each time slice from the time origin up to a time slice of interest of a first quantity associated with the dated requirements of the client site; and
a second running total for each time slice from a time origin up to a time slice of interest, of a second quantity associated with the stock and the purchases, wherein the purchases are shifted timewise according to a delay in time; and
searching the at least one table for times at which the second running total is less than the first running total which is indicative of a risk of at least one of a supply shortage and a necessity of initiating supply.

2. The method according to claim 1, further comprising:
periodically shifting the running totals to a new time origin when there is substantial equality between first totaled quantities and second totaled quantities.

3. The method according to claim 1, wherein the creating and the producing are reiterated in view of predetermined events.

4. The method according to claim 3, wherein the predetermined events comprise at least one of modification of a project date by the at least one client, modification of an availability date by the at least one client, modification of a supply delay by the at least one supplier, modification of product quantities to be provisioned, placing of an order from the at least one client to the at least one supplier, confirmation of an order, reservation of a product from stock, and delivery of a product.

5. The method according to claim 1, wherein the searching further comprises taking an order no later than a date substantially equal to a start-up date of a project, wherein the date is increased by supply availability and reduced by a supply delay.

6. The method according to claim 1, wherein the producing further comprises:
classifying requirements of the stock and the purchases by product and by effective date;
forming a running total of the requirements for each product and in each time slice in a sequence, from a time origin, to create a first table; and
forming a running total of the stock and deliveries provided for each product, and in each time slice in the sequence, from the time origin to create a second table.

7. A system for monitoring a supply between at least one supplier and at least one client using a computer, the system comprising:
a monitoring module configured to maintain in memory a dated state of requirements for products associated with at least one project and further configured to concurrently maintain in memory a state of stock and purchases of the products;
the monitoring module comprising a control module that includes:
a requirements module configured to produce, for each product type, a first table associated with a sequence of time slices having a chosen time origin, wherein the first table associates with each time slice a first running total of requirements from a time origin up to a time slice of interest;
a resources module configured to produce, for each product type, a second table associated with a sequence of time slices, wherein the second table associates with each time slice a second running total of stock and purchases from the time origin up to the time slice of interest, wherein the purchases are shifted timewise according to a delay in time; and
a comparator that searches for times at which second running totals are less than first running totals which are indicative of a risk of a supply shortage.

8. A system for monitoring a supply between at least one supplier and at least one client, the system comprising:
a monitoring module configured to maintain in memory a dated state of requirements of products associated with one or more projects and configured to maintain in memory, at the same time, a state of the stock and purchases of the products;
the monitoring module comprising:
a running total module that receives, as parameters, a designation of a product type, a mode, and a time origin, the running total module produces, for the designated product type, a table associating successive time slices with a running total of product quantities being defined by the mode, wherein each running total goes from the time origin up to a time slice of interest; and
a control module that calls the running total module with a product type and a mode of requirements on a client site, to which the running total module supplies a first table;
the control module calls the running total module with the same product type, and a mode of stock and deliveries, to which the running total module supplies a second table; and
the control module searches for times at which the running totals in the second table become less in the first table, which are indicative of a risk of supply shortage.

9. The system according to claim 8, wherein the control module is configured to periodically shift the running totals to a new time origin when there is a substantial equality between the first totaled quantities and the second totaled quantities.

10. The system according to claim 8, wherein the control module is configured to operate in a reiterated manner in view of predetermined events.

11. The system according to claim 10, wherein the predetermined events comprise at least one of modification of a project date by the client, modification of an availability date by the client, modification of a supply delay by the supplier, modification of the product quantities to be provisioned, placing of an order from the client to the supplier, confirmation of an order, reservation of a product from stock, and a delivery of a product.

12. The system according to claim 8, wherein the control module is configured to order a product, no later than a date substantially equal to a start-up date of the project, increased by a supply availability, and reduced by a supply delay.

13. The system according to claim 8, further comprising:
a state module, configured, on the client side, to classify the requirements of the stock and the purchases, by product and by effective date;
the state module forms a running total of the requirements for each product in each time slice in a sequence to create the first table; and
the state module forms a running total of the sum of stock and purchases for each product, and in each time slice in the sequence, to create the second table, the control module operating from the data of the state module.

14. The system according to claim 13, wherein the control module at least partially incorporates the state module.

15. The system according to claim 7, wherein the monitoring module manages a list of product types involved in one or more projects.

16. The system according to claim 7, implemented in object-oriented programming and further comprising:
an object class for the products;
an object class for the stock;
an object class for the purchases; and
an object class for a table element comprising a quantity and a time.

17. The system according to claim 16, further comprising an object class for each project.

18. A computer readable medium product comprising a program for executing the method according to claim 1.

19. A computer readable medium product comprising a program for implementing functions of the monitoring module in the system according to claim 7.

20. A computer readable medium comprising a program, in object-oriented programming, the program implementing functions of the monitoring module and the object classes according to claim 17.
